(19) United States
(12) Patent Application Publication
(10) Pub. No.: US 2012/0091979 A1
(43) Pub. Date: Apr. 19, 2012

(54) HIGH GAIN DC TRANSFORMER

(75) Inventor: Dragan Jovcic, Aberdeenshire (GB)

(73) Assignee: UNIVERSITY COURT OF THE UNIVERSITY OF ABERDEEN, Aberdeen, Aberdeenshire (UK)

(21) Appl. No.: 12/747,662

(22) PCT Filed: Dec. 2, 2008
(86) PCT No.: PCT/GB2008/051141

§ 371 Date: Aug. 27, 2010

(30) Foreign Application Priority Data
Dec. 13, 2007 (GB) 0724369.4

(51) Int. Cl. H02M 3/142

(52) U.S. Cl. 323/272

(57) ABSTRACT

A DC-DC power converter circuit (20) is provided for transferring power between low voltage terminals and high voltage terminals. The circuit comprises an inductor (Lᵣ) and a capacitor (Cᵣ) provided across the low voltage terminals, the capacitor being provided in parallel with the high voltage terminals. The circuit further comprises a plurality of switches (T₁ to T₄) for switching the polarity of the capacitor in the circuit, and a controller for controlling the switching of the capacitor to repeatedly switch the polarity of the capacitor at a switching frequency f, such that, in use, and other than at the instant of switching, the switched capacitor produces an increasing voltage at the high voltage side of the inductor. A connection device (D₂) is provided for repeatedly connecting the high voltage terminals to the switched capacitor at substantially the switching frequency f to enable current flow between the switched capacitor and the high voltage terminals.

The present invention relates to a circuit for a DC-DC (direct current to direct current) power converter.

DC-DC power converters are used extensively at low power levels, and many different topologies exist. However, it has previously been difficult to transfer power with high voltage stepping (high gain), and, in particular, to obtain high boost levels. In this respect, conventional simple boost converters are not able to achieve voltage stepping ratios of greater than 2-3 because of practical difficulties with diode recoveries, switch ratings, and the influence of parasitic elements when operating at extreme duty ratios [1,2]. Accordingly, flyback or forward converters [1,3,4], are typically used to achieve higher voltage stepping ratios. However, such converters require an intermediate AC transformer which significantly increase the complexity and weight of the device. Further, whilst flyback and forward converters might be an acceptable solution for low power applications, they have numerous limitations and disadvantages at higher powers, such as high losses and switch stresses.

When a voltage boost of around 10 is required, it has previously been found that it is most effective to use two stages of ordinary boost converters [2], despite low efficiency and complexity. Recently, switched capacitor converters have been proposed, which achieve high boost without the use of transformers [5]. However, these converters are modular, and become very complex and suffer high losses if high stepping ratios are required. In this respect, each module, which comprises one capacitor and a set of switches, only increases the output voltage by the value of the input voltage. Accordingly, if high gains (high stepping ratios) are needed, many modules are required.

In recent years, power sources which generate DC have increased in size and number, and it is predicted that this trend will continue [6-9]. Such sources include, but are not limited to, fuel cells, photovoltaic cells, batteries, redox flow and thermoelectric sources. Further, all variable speed machines, such as permanent magnet wind generators or small hydro-generators, may be considered DC sources if the final converter stage is removed. In addition, many electrical storage and load leveling devices use storage media which are typically based on DC power. For example, batteries, capacitors, super-capacitors, superconducting magnetic energy storage, etc). Many of these DC sources use very low voltage basic cells, or require wide variation of DC voltage. Accordingly, their integration into the power grid has previously been problematic due to the need for high-power, high stepping DC to DC converters.

At higher power levels, AC side voltage stepping by means of conventional iron-core transformers is traditionally used, although high-power DC transmission circuits are becoming more common. This is primarily due to the introduction of HVDC (high voltage direct current) light [10], which is promoted as a suitable solution for integration of renewable power sources. Accordingly, there is an increasing requirement for high-gain DC voltage stepping at higher power levels for use in power systems which involve DC sources.

In particular, there is a requirement for a cost-effective, high-gain DC transformer, which would have many applications across a wide range of power levels. Indeed, such a transformer could also potentially replace existing AC side transformers in mixed (AC and DC) systems.

The main difficulty in the operation of conventional boost converters [1] is that their voltage stepping ratio is directly linked with the magnitude of the control signal. As a result, the operation becomes very difficult as the control signal approaches extreme values (ie, duty ratio of close to zero or one). The problems are manifested in two ways [1]. Firstly, there is a theoretical limit on the stepping ratio. Secondly, there is hard switching of both the main switch and the output diode, which means that components of large ratings are required. Further, the reverse recovery issues with the diode call for complex snubbers which significantly increase losses.

It is an object of the present invention to overcome the limitations of the prior art.

According to one aspect of the present invention there is provided a DC-DC power converter circuit for transferring power between low voltage terminals and high voltage terminals, the circuit comprising:

an inductor and a capacitor provided across the low voltage terminals, the capacitor being provided in parallel with the high voltage terminals;

a plurality of switches for switching the polarity of the capacitor in the circuit; and

a controller for controlling the switching of the capacitor to repeatedly switch the polarity of the capacitor at a switching frequency f, such that, in use, and other than at the instant of switching, the switched capacitor produces an increasing voltage at the high voltage side of the inductor.

Thus, the present invention effectively utilises a rotating capacitor in an LC circuit to achieve a constant or permanent voltage increase at the high voltage side of the inductor (ie, the side of the inductor connected to the high voltage terminals). That is to say, dV_{cr}/dt is positive, where V, is the voltage produced by the switched capacitor at the high voltage side of the inductor.

It will be appreciated that the plurality of switches simply “rotate” the capacitor to change its polarity in the circuit. Thus, the capacitor remains connected in parallel with the high voltage terminals whilst its polarity is switched.

The constantly increasing voltage at the high voltage side of the inductor enables power to be transferred from the low voltage side of the circuit to the high voltage side of the circuit (step-up operation), and enables power to be transferred from the high voltage side of the circuit to the low voltage side of the circuit (step-down operation), as explained in more detail below.

The theoretical voltage achievable in boost or buck mode, under any non-zero and constant switching frequency (control signal), is infinity. Thus, the output voltage of the circuit is only limited by the rating of the components.

Moreover, although the converter of the present invention does not provide electrical isolation, studies of the circuit have shown that there is good tolerance to fault propagation through the converter, which makes it suitable for high power applications.

In particular, the circuit of the present invention addresses the problem, seen with conventional boost converters, of the output voltage level being directly linked with the magnitude of the control signal, such that operation becomes difficult as the control signal approaches extreme values. In this respect, the present invention enables very high voltage stepping ratios with minimal control action, and minimal sensitivity to the voltage level changes.

Moreover, the circuit of the present invention does not require an iron-core transformer, and involves less complex electronic circuitry than conventional high-gain converters, such as flyback or forward converters, and is thus simpler and cheaper to manufacture. In this respect, the circuit of the present invention may utilise thyristors and diodes, which are low cost, and have low losses and high power ratings. In contrast, previously known boost converters require switches with turn off ability, which have lower power ratings, higher losses and are high cost.

Further, simulation testing has shown that converters embodying the present invention can operate at relatively low switching frequencies, such that switching losses are low. Moreover, the load current is passed through only three or four switches at any one time, which further reduces conduction losses.

The inductor and the capacitor may be provided in series across the low voltage terminals.

The circuit may further comprise rectification circuitry for rectifying the voltage on the high voltage side of the inductor. The rectification circuit may have soft on-switching, ie, switching at zero current and zero voltage, which allows for the use of smaller switches and for larger power transfers.

The circuit may further comprise a connecting device for repeatedly connecting the high voltage terminals with the switched capacitor at substantially the switching frequency to enable current flow between the switched capacitor and the high voltage terminals.

In step-up operation, the connecting device effectively allows the capacitor to be discharged to a high voltage load once per cycle, to transfer power from the low voltage side of the circuit to the high voltage load. In step-down operation, the connecting device connects the high voltage to the switched capacitor once per cycle to allow power to be transferred from the high voltage side to the low voltage side.

According to another aspect of the present invention, there is provided a DC-DC power converter circuit for transferring power between low voltage terminals and high voltage terminals, the circuit comprising:

an inductor and a capacitor provided in series across the low voltage terminals, the capacitor being provided in parallel with the high voltage terminals, and configured into an electronic bridge circuit comprising a plurality of switches whereby the polarity of said capacitor with respect to said low or high voltage terminals can be changed;

a controller for selectively actuating said switches so as to repeatedly switch the polarity of the capacitor with respect to the high voltage terminals at a predetermined cycling frequency; and

a connection device for repeatedly connecting the high voltage terminals to the switched capacitor at substantially said cycling frequency to enable current flow between the switched capacitor and the high voltage terminals.

Other than at the instant of switching, the switched capacitor may produce an increasing voltage at the high voltage side of the inductor.

The plurality of switches may be thyristors.

In particular, the switches may comprise four thyristors forming a four thyrsitor bridge around the capacitor in the LC circuit constituted by the inductor and the switched capacitor. Using thyristors as the switches brings significant advantages in terms of cost and further reduces switching losses. Moreover, with thyristors, very large power rating is possible.

A converter which embodies the present invention can supply a passive load at either high-voltage or low-voltage side, despite the use of thyristors. The switches require reverse blocking capability. As an alternative to thyristors, other types of switches such as MOSFET, IGBT, GTO, etc may be used, if a series diode is added to provide reverse blocking.

The connector device may repeatedly connect the high voltage terminals with the switched capacitor with predetermined timing in relation to the switching frequency.

The connector device may comprise a single component such as a single diode, or may comprise a plurality of components, such as a four diode bridge.

A further inductor may be connected to the high voltage terminals.

The connector device may comprise a thyristor T_{d} provided in series with an inductor L_{d}.

The circuit may be for a step-up converter, or for a step-down converter.

Further, the circuit may be for a bi-directional converter capable of operation in step-down and/or step-up mode. In this case, the connector device may comprise a pair of thyristors Tᵤ, T_{d} provided in parallel, and provided in series with an inductor L_{d}.

The thyristor Tᵤ, T_{d} and the inductor L_{d} would be in addition to the bridge thyristors which may be employed for switching the capacitor, and the inductor which constitutes the LC circuit together with the switched capacitor.

Where the connector device comprises thyristor(s) Tᵤ, T_{d} each of the one or more thyristors Tᵤ, T_{d} may be controllable by the aforementioned controller, or a separate controller.

The capacitor may have a value Cᵣ substantially equal to I₂/(2fV₁), where I₂ is the average current through the high voltage terminals, f is the switching frequency and V₁ is the voltage across the low voltage terminals.

The capacitor may be switched at a switching frequency f≦2f_{c}, where f_{c} is the natural frequency of the LC circuit constituted by the inductor and the capacitor.

This results in discontinuous mode operation of the converter, which has intervals of zero current on the low voltage side. Discontinuous mode operation has the advantage of low switching losses, due to the fact that the initial and final current for each switching cycle is zero.

In discontinuous mode operation, the inductor may have a value Lᵣ of less than or equal to 1/(π²f²Cᵣ), where f is the switching frequency and Cᵣ is the value of the capacitor.

Alternatively, the capacitor may be switched at a switching frequency f>2fₒ, where fₒ is the natural frequency of the LC circuit.

This results in continuous mode operation of the converter. In continuous mode, the switching frequency is higher than in discontinuous mode, which results in lower input current ripple. Moreover, a lower value capacitor than required for discontinuous mode operation may be employed, with consequent cost savings.

Embodiments of the present invention will now be described with reference to the accompanying drawings in which:

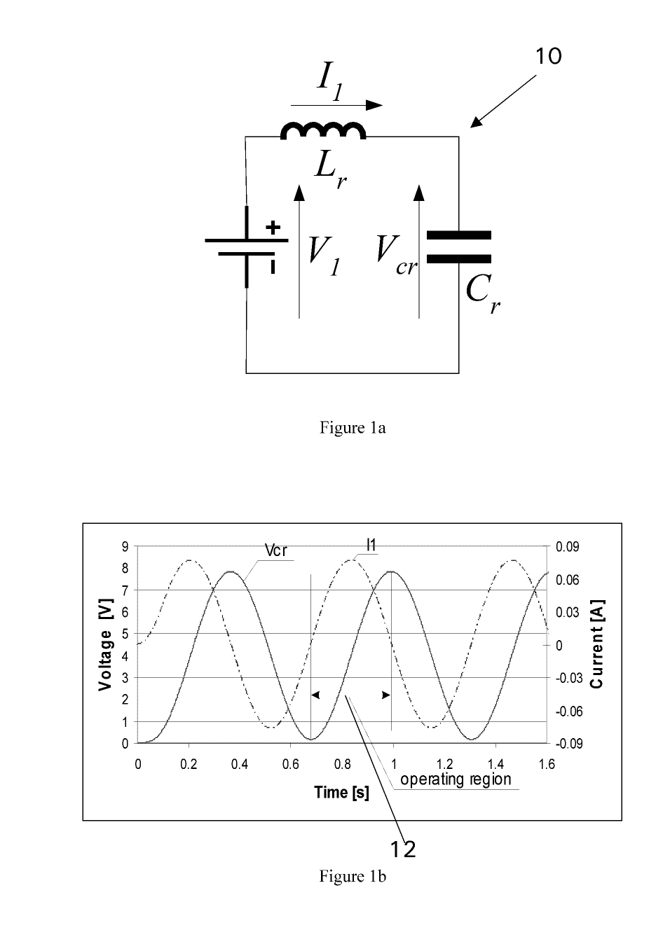

FIG. 1a shows a simple LC circuit;

FIG. 1b shows the variation of voltage and current with time for the LC circuit of FIG. 1;

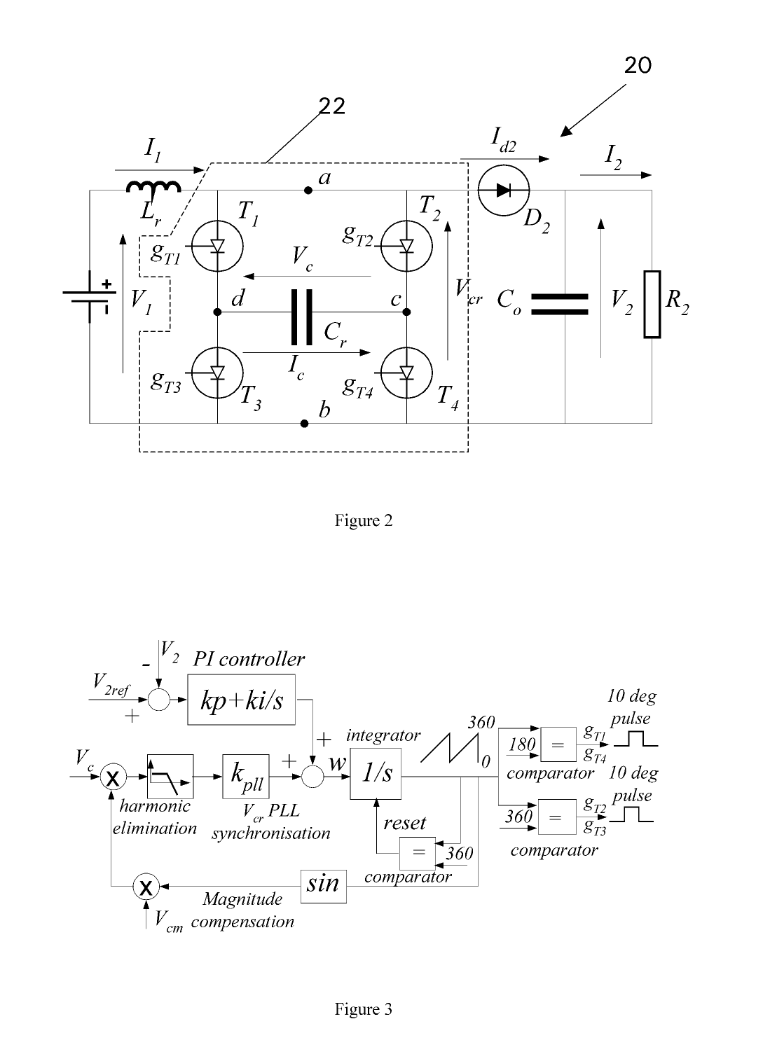

FIG. 2 shows the topology of a step-up converter in accordance with a first embodiment of the present invention;

FIG. 3 shows a simplified schematic for a controller structure for the converter of FIG. 2;

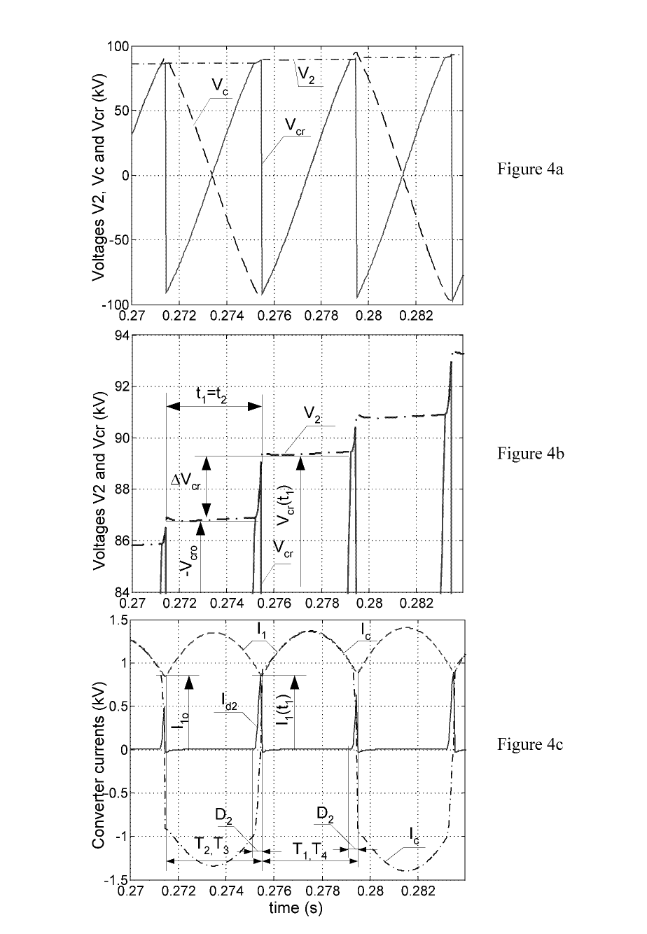

FIGS. 4a, 4b and 4c give the results of a PSCAD simulation of continuous current operation of the converter of FIG. 2, when lightly loaded;

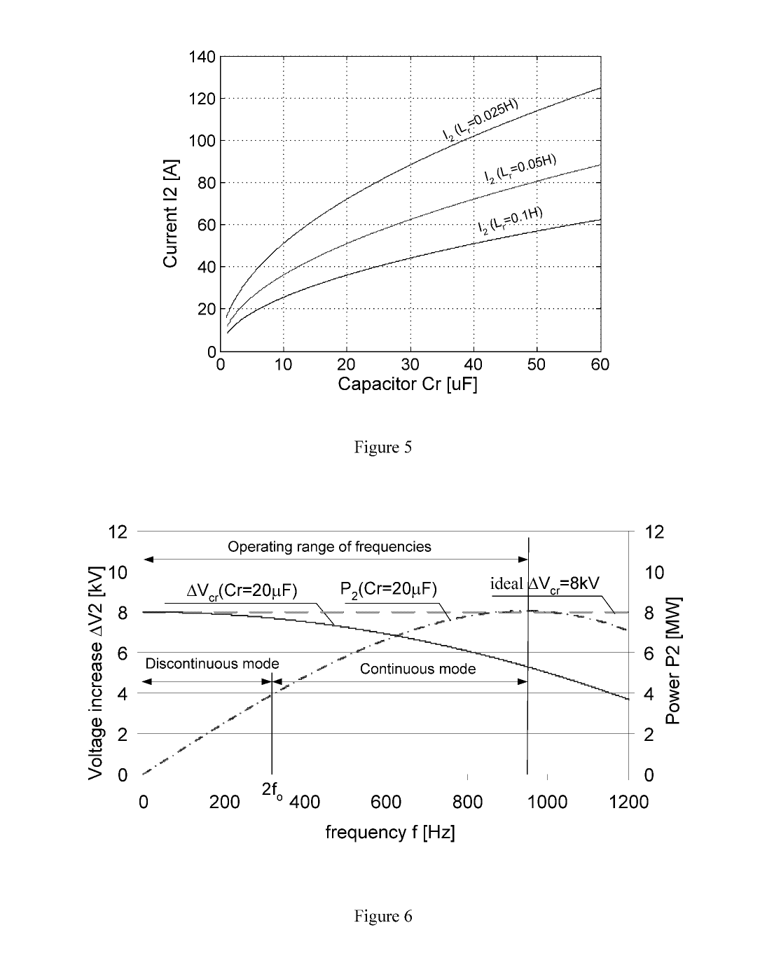

FIG. 5 shows current on the high voltage side as a function of the capacitor size for the circuit of FIG. 2, with an input voltage of 4 kV, a constant operating frequency and a constant impedance load;

FIG. 6 shows, for the circuit of FIG. 2, the steady-state power and capacitor voltage rise as a function of operating frequency in the continuous operating mode, with a constant input voltage of 4 kV, a constant output voltage of 80 kV and including switching and parasitic losses;

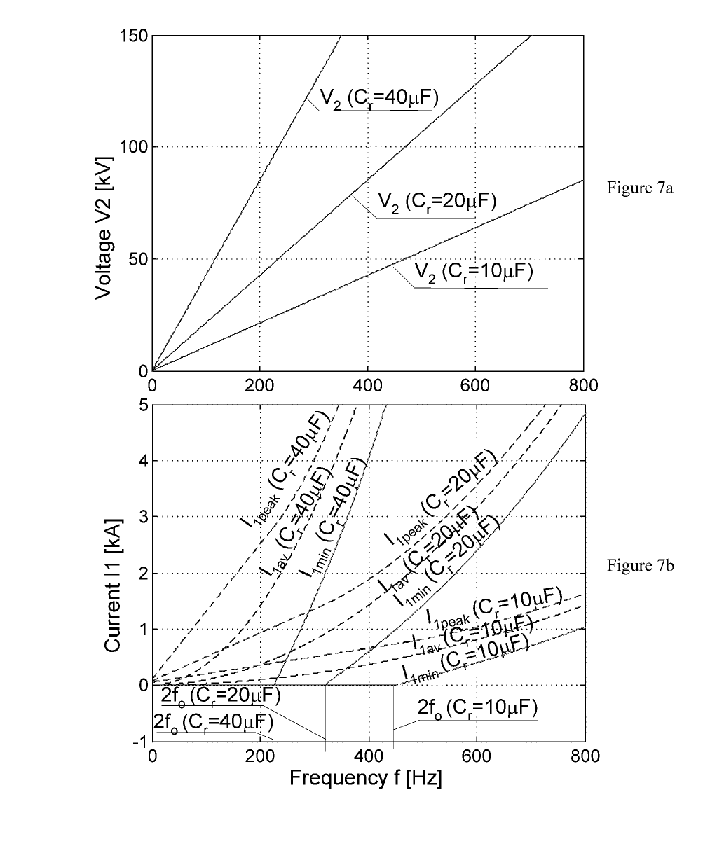

FIGS. 7a and 7b show, for the circuit of FIG. 2, the operating point as a function of switching frequency for a constant impedance load;

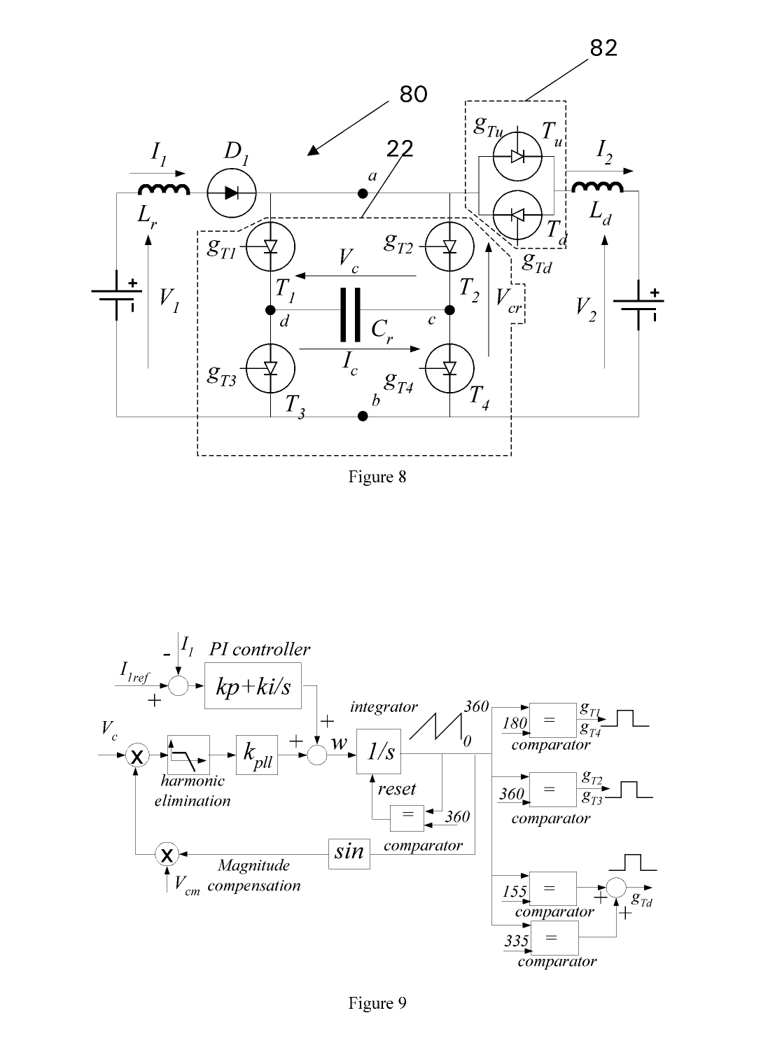

FIG. 8 shows the topology of a bi-directional converter in accordance with a third embodiment of the present invention;

FIG. 9 illustrates the control system for step-down operation of the bi-directional converter of FIG. 8;

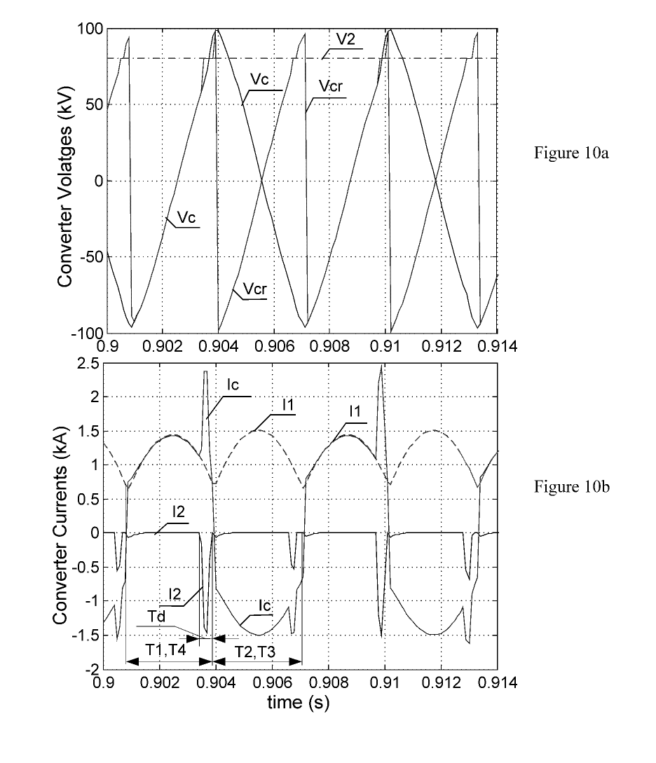

FIGS. 10a and 10b give the results of a PSCAD simulation of the bi-directional converter of FIG. 9 operating in step-down mode;

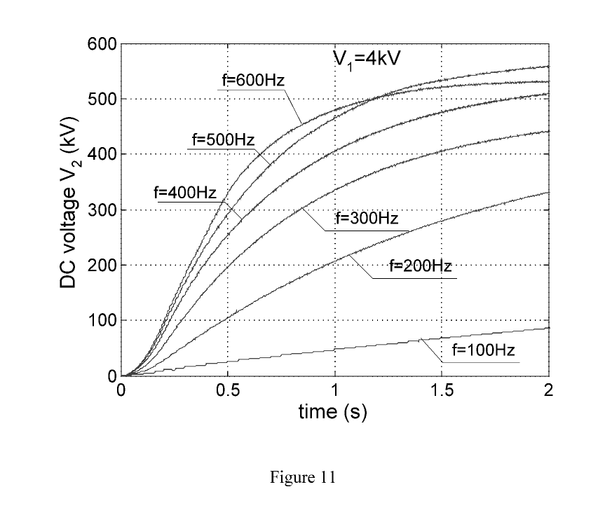

FIG. 11 gives PSCAD simulation test results for an embodiment of the present invention, operating in step-up mode, with an unloaded output, an input voltage of 4 kV, and a constant switching frequency;

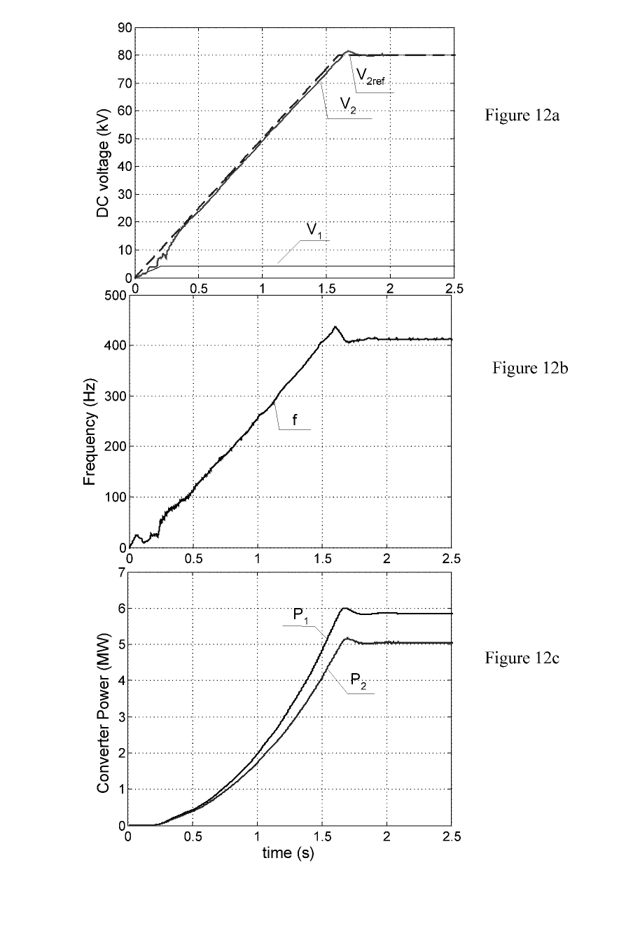

FIGS. 12a to 12c give PSCAD simulation test results for step-up power transfer with a constant impedance passive load on V₂, and with a feedback voltage controller;

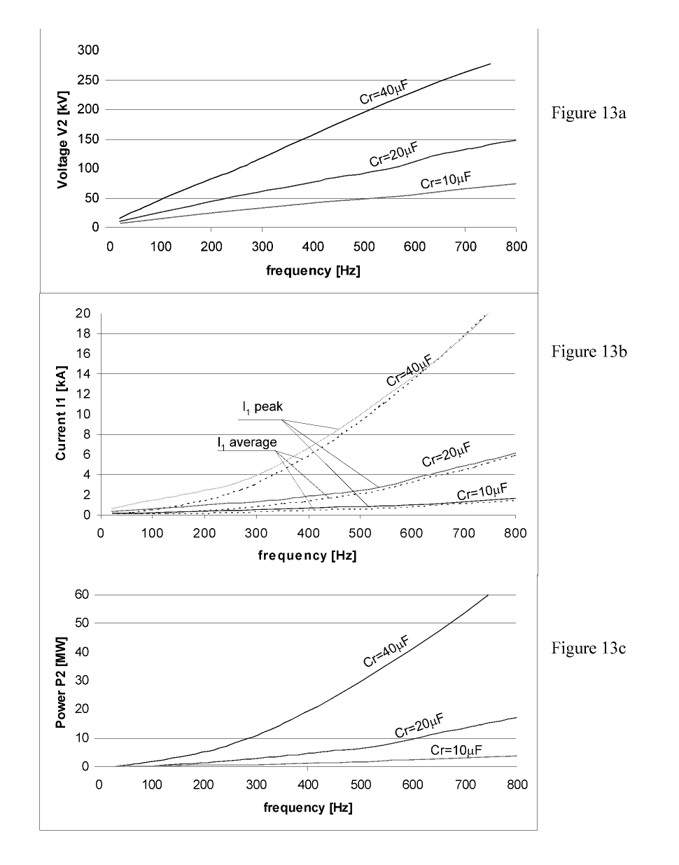

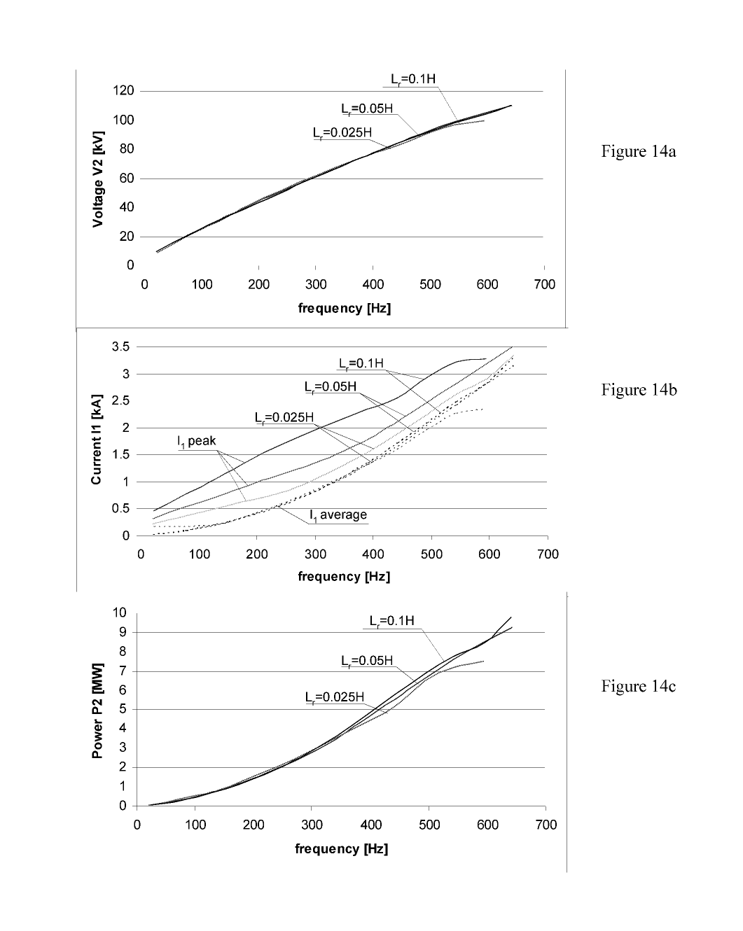

FIGS. 13a to 13c summarise PSCAD simulation tests of the influence of the size of the capacitor Cᵣ, when operating with a constant impedance load in step-up operation;

FIGS. 14a to 14c summarise PSCAD simulation tests of the influence of the size of the inductor Lᵣ when operating with a constant impedance load in step-up operation;

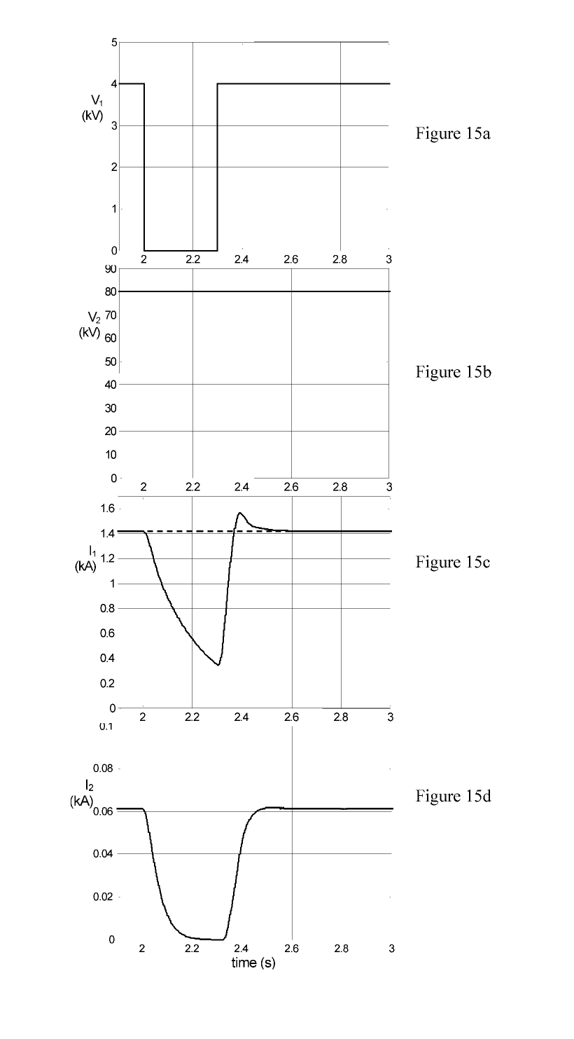

FIGS. 15a to 15d illustrate simulated responses for a 0.3 s low-impedance fault at V₁ in step-up operation;

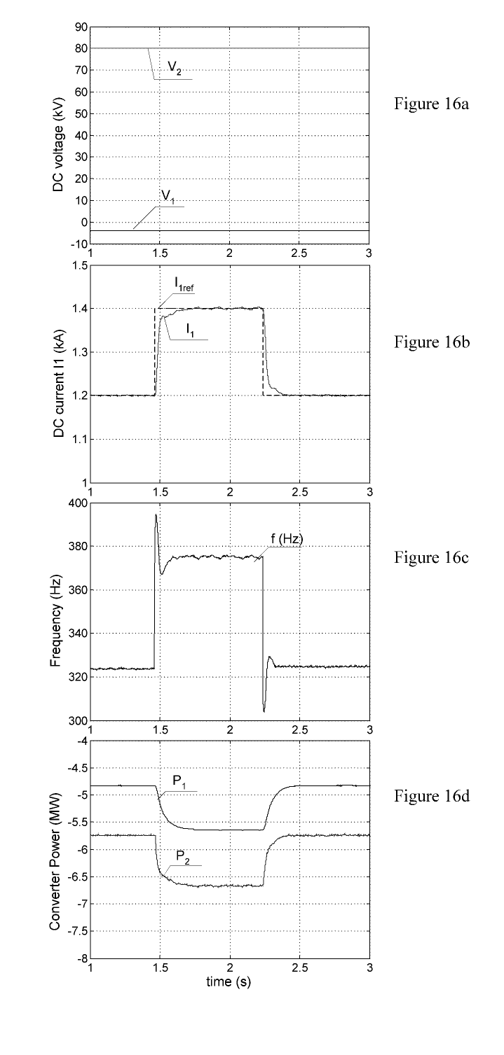

FIGS. 16a to 16d gives simulation test results for step-down operation, in current control mode, of a converter which embodies the present invention; and

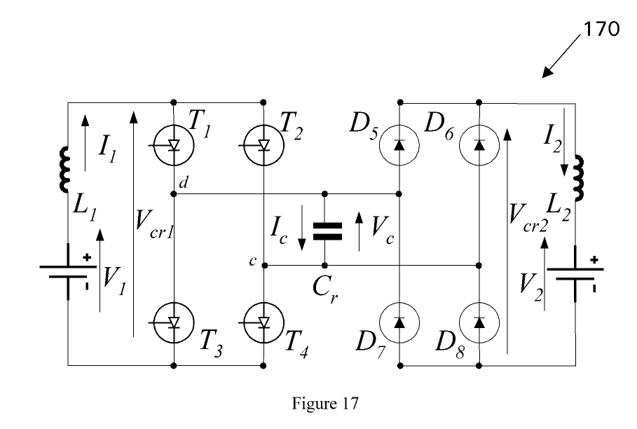

FIG. 17 shows the topology of a step-up converter in accordance with a second embodiment of the present invention.

In the figures, elements common to different figures and/or different embodiments are given common reference numerals.

The present invention concerns a DC-DC power converter which utlises a rotating capacitor in an LC circuit to achieve operation at a permanently positive voltage derivative, and thus a permanent voltage increase, at the high voltage side of the inductor.

The principles of the present invention may be understood by analysis of the simple LC circuit 10 shown in FIG. 1a. The LC circuit 10 of FIG. 1a, comprises an inductor Lᵣ and a capacitor Cᵣ connected in series, and driven by a voltage source V₁. The time domain response of the current in the circuit, I₁, and the capacitor voltage V_{cr}, are given by equations (1) and (2).

I₁(t)=I₁₀ cos(ωₒ(t−t₀))+((V₁−V_{cr0})/z₀)sin(ωₒ(t−t₀)) (1)

V_{cr}(t)=V₁−V_{cr0})cos(ωₒ(t−t₀))+z₀I₁₀sin(ωₒ(t −tₒ)) (2)

where t is time, t₀ is the initial time, I₁₀ is the initial value of I₁ (ie, at t=t₀), ω₀=2πf₀=1/√(LᵣCᵣ) is the natural frequency of the LC circuit, V₁ is the input voltage, V_{cr0} is the initial value of V, in each cycle (at t=t₀), z₀=√(Lᵣ/Cᵣ), Lᵣ is the inductance of the inductor Lᵣ, and Cᵣ is the capacitance of the capacitor Cᵣ.

Graphs of I₁(t) and V_{cr}(t) are illustrated in FIG. 1b.

To achieve a permanent voltage increase, the first derivative of the voltage with time, dV_{cr}/dt, must be permanently positive.

From equation (2), the first derivative of the voltage V_{cr}(t) is given by:

dV_{cr}/dt=ωₒ(V₁−V_{cr0})sin(ωₒ(t−t₀))+ωₒz₀I₁₀ cos(ωₒ(t−t₀)) (3)

By analysis of equation (3), it can be concluded that dV_{cr}/dt is positive where V_{cr0}<V₁ (condition 1) and where 0<ωₒt<π (condition 2).

The present inventors have established that condition 1 can be satisfied by “rotating” the capacitor Cᵣ such that it changes polarity in the circuit when the capacitor voltage exceeds −V₁, and before it reaches its peak. By rotating the capacitor at an instant t₁, when the capacitor voltage is V_{cr}(t₁), the initial voltage in the next cycle becomes V_{cr0}=−V_{cr}(t₁) . This can be achieved by means of suitable switches. Therefore, the first term in equation (3) becomes positive, and the magnitude of the voltage is proportional to V₁−V_{cr0}.

Condition 2 requires that operation takes place in the positive current region identified as 12 in FIG. 1b, where the capacitor voltage V_{cr} increases. Under this condition, V_{cr} at the end of the cycle will be larger than the value at the end of the previous cycle, as proven below. The positive current is ensured by the appropriate electronic H-bridge, which only conducts in one direction.

The capacitor must be rotated at a frequency of ω=2πf>2ωₒ (condition 3), ie, switched in less than half the natural cycle, if the current I₁ is required to be continuous.

In cases where the source V₁ can not tolerate a large ripple current, the inductor size can be increased, the operating frequency can be increased by using a smaller capacitor, or an additional input LC filter may be employed.

From equation (3), it can also be concluded that the magnitude of dV_{cr}/dt (ie, the slope of voltage increase) is directly proportional to both the natural frequency of the circuit, ωₒ, and V₁−V_{cr0}. Thus, the higher the natural frequency of the circuit, the steeper the voltage rise. This in turn will raise the lower limit for the switching frequency (from condition 3).

It can also be concluded from equation (3) that the initial current I₁₀ has influence on the slope of voltage rise in such a way that a higher initial current will increase the voltage derivative. A higher initial current is achieved if the switching frequency is higher, since this implies a shorter conducting interval t₂, ie, operation takes place in a narrower region around the current peak.

From equation (3), it can also be concluded that the system is self-starting from an un-energised state because dV_{cr}/dt>0 for V_{cr0}=0. This is important in practice, since it means that it will be simple to initially charge capacitors Cᵣ and Cₒ to the high operating voltage, such that no special pre-charging circuits are required.

The present inventors have used the above principles to develop practical converters that achieve permanently increasing DC voltage for a constant operating frequency (control input). At the end of each cycle, the voltage on the switched capacitor will be higher than in the previous cycle by a certain value. The voltage therefore increases with each switching step.

FIG. 2 shows a circuit diagram for a step-up converter 20 in accordance with a first embodiment of the present invention. As with the LC circuit of FIG. 1, the converter circuit 20 comprises an inductor Lᵣ and a capacitor Cᵣ, and is driven by a voltage source V₁. However, in the circuit of FIG. 2, the capacitor Cᵣ is connected between four thyristor switches T₁ to T₄. That is to say, capacitor Cᵣ in FIG. 1 is replaced with a block 22 which comprises two pairs of series connected thyristor switches T₁ and T₃, and T₂ and T₄. The pairs of switches are connected to one another in parallel, with the capacitor Cᵣ connected between a node d, located between switches T₁ and T₃, and a node c located between switches T₂ and T₄. The capacitor Cᵣ will be operating under alternating voltage and alternating current conditions. Thus, a suitable AC graded capacitor is required.

With this arrangement, the polarity of the capacitor Cᵣ in the circuit can be changed by firing switches T₁ and T₄ followed by switches T₂ and T₃. The capacitor can thus be “rotated” in the circuit by alternately firing switches T₁ and T₄ together, and T₂ and T₃ together. In this way, the capacitor always stays connected in parallel with the high voltage connection. However, the polarity of the capacitor repeatedly reverses. This principle is different from the switched capacitor converters of reference [5], in which the capacitors are sequentially connected in series with the high voltage load.

The firing of the switches T₁ to T₄ is at 50% duty cycle (equal conduction interval for the T₁/T₄ pair as for the T₂/T₃ pair) and the frequency of rotation is the external control signal.

The commutation of capacitor current from one converter leg to the other is always assured. This means that the converter naturally extinguishes thyristor current. For example, by firing T₁, the input current I₁ is transferred from T₂ to T₁ since T₁ provides lower cathode voltage and a lower resistance current path.

This natural commutation means that the switches do not need turn-off capability, and thus allows for the use of thyristors for switching the capacitor. However, alternative switches may be used, as appropriate for the specific application. For example, MOSFET, IGBT, GTO, etc.

The rectification side of the circuit 24 of FIG. 2 comprises a diode D₂, a high voltage side capacitor Cₒ, and a load represented by a resistance R₂. The diode D₂ is connected to block 22 via a node a located between switches T₁ and T₂. The high voltage side capacitor Cₒ is connected to the other side of the diode D₂, and in parallel with block 22. The load R₂ is connected in parallel with the output capacitor. This rectification circuitry is one of the simplest arrangements possible. In practice, other rectification circuits could be used, which may comprise further switches and could be connected to block 22 via any of nodes a, b, c and d, respectively located between switches, T₁ and T₂, T₃ and T₄, T₂ and T₄, and T₁ and T₃.

In FIG. 2, the voltage across block 22 V_{cr} (ie, at the high voltage side of the inductor) is shown to have a sawtooth waveform (ie, constantly increasing, other than at the instant of switching), where the slope of the ramp is dependent on the natural frequency ωₒ of the circuit, the initial voltage V_{cr0} (assumed to be equal to the output voltage V₂) and the initial current I₁₀. In unloaded operation, the sawtooth waveform will have voltage peaks of increasing magnitude. The V_{cr0} voltage increase over the previous cycle represents the energy transferred from the low voltage source V₁ to the switched capacitor Cᵣ.

The rise on voltage V_{cr} is restricted by the current I_{d2} through the diode D₂, which charges the high voltage side capacitor Cₒ. The high voltage side capacitor voltage V₂ is balanced by the diode current and the load current I₂ as follows:

V₂=(1/Cₒ)∫₀^{2π/ω}(I_{d2}−I₂)dt (4)

Equation (4) considers integration over one full cycle, and implies averaging, because the diode current I_{d2} will be discontinuous. Diode D₂ could potentially be replaced by a further thyristor in order to improve fault tolerance, in particular, tolerance to faults on the high-voltage side.

FIG. 3 shows a simplified schematic for a controller for controlling the switching of the circuit of FIG. 2. The controller comprises a primary feedback PI regulator which controls the output voltage V₂. Alternatively, the output current I₂ or the input current I₁ or power, or some other variable could be controlled, depending on the application.

The controller also comprises a phase locked loop (PLL), which aids in synchronising the firing of switches T₁ to T₄ with the capacitor voltage. The PLL improves stability at low operating frequencies, where time intervals between rotations are long. However, at high operating frequencies and high natural LC frequencies, the PLL may be omitted.

Where a PLL is required, it should have voltage magnitude compensation which could resemble that proposed in [7].

The frequency of the firing circuit is controlled by the PI controller and the PLL, and is integrated to obtain the phase ramp.

The switches T₁ to T₄ are always fired at a constant phase angle, implying a 50% duty ratio. In this respect, T₁ and T₄ may be at 180 degrees, whilst T₂ and T₃ may be fired at 360 degrees, typically with around 10 degree pulses for thyristor latching.

The circuit of FIG. 2 has been tested using PSCAD, with test system data as given in Table 1.

TABLE 1

| Cᵣ [μF] | Lᵣ [H] | Cₒ [μF] | R₂ [Ω] | V₁ [kV] | L_{d} [H] |
|---|---|---|---|---|---|
| 20 | 0.05 (0.1 in | 50 | 1330 | 4 | 0 |
| | step down) | | | | |

In the present case, the circuit of FIG. 2 with the test system data of Table 1, was controlled to boost a 4 kV input voltage to 80 kV. At 80 kV, the output power was 5 MW. Higher voltages have also been achieved with the circuit of FIG. 2.

FIGS. 4a to 4c illustrate details of the PSCAD simulation of the converter of FIG. 2 under very light loading. From FIGS. 4a and 4b it can be seen that V_{cr} has a permanently increasing sawtooth waveform, which is clipped as it reaches the level of V₂. The diode D₂ discharges V_{cr} to the output capacitor once per cycle. In every cycle, there is an increase in the peak value of V_{cr}. This increase is identified as ΔV_{cr} in FIG. 4b. ΔV_{cr} represents the energy stored in the capacitor Cᵣ in one cycle, and which can be transferred to the output load.

With reference to FIG. 4c, the input current I₁ has a positive average value with some ripple which is proportional to the switching frequency, the inductor size and the loading. The current I₁ is positive, and, when multiplied by the positive voltage V₁, gives the electrical power taken by the converter input stage. This power is transferred to the switched capacitor and results in the peak voltage V_{cr} increase in each cycle. In the test system illustrated in FIGS. 4a to 4c, the current I₁ is continuous. However, at lower switching frequencies, the current I₁ will become discontinuous. In such cases, the current I₁ will start from zero and will have full half-cycle. It will then end at zero and remain at zero until the next switching instant. Current I₁ can not become negative because of the connection of the four switches T₁ to T₄, and the diode D₂.

The high voltage diode current I_{d2} has conducting intervals where the conduction interval length and the current magnitude depend on the voltage stepping ratio, the size of the output capacitor and the loading. The diode D₂ has soft on-switching since it naturally turns on when the V_{cr} voltage exceeds the V₂ voltage. This is a significant advantage because similar diodes employed in previously known boost converters have hard on-switching. If the diode current gradient is of concern, it can be reduced by locating a small inductor in series with D₂.

Balanced operation of the converter is achieved when the power transfer through the converter matches the load power, and the output voltage remains constant.

Steady-state operation of the converter is achieved if the capacitor voltage V_{cr} at the end of each cycle equals the initial voltage V_{cr0} (with the opposite sign), and it equals voltage V₂. Since the current I₁ does not change polarity, in balanced operation the current at the beginning of the cycle I₁₀ equals the current at the end of the cycle.

Power transfer is achieved by the theoretical increase of the capacitor voltage V_{cr} at the end of the switching interval, compared with the initial value V_{cr0}, ie, ΔV_{cr}. This theoretical increase corresponds to the actual voltage increase in unloaded operation.

At a time t₂ which denotes the length of one conduction interval, in steady state:

I₁(t=t₂)=I₁₀ (5)

and

V_{cr}(t=t₂)=−V_{cr0}+ΔV_{cr} (6)

The voltage increase is balanced by the output load current I₂ as follows:

ΔV_{cr}/t₁=I₂/Cᵣ (7)

where t₁ is the switching interval (t₁=1/f=1/2πω). The load current I₂ is drawn from the capacitor Cₒ during the whole interval t₁. However, the switched capacitor is charged only during the conducting interval t₂, which may be shorter than or equal to t₁.

Both continuous and discontinuous mode operation are possible with the present invention. In the case of continuous operation, t₂=t₁. Whereas, in the case of discontinuous operation, there will be an interval where input current is zero and therefore t₂<t₁. In equation (7), it is assumed that the average diode current is equal to the load current, ie I_{d2}=I₂, in steady-state. This condition can be derived from equation (4) assuming that the voltage V₂ is constant.

Considering first the discontinuous operating mode of the present invention, the length of the current conduction interval t₂, is equal to half the natural LC cycle, ie:

t₂=π/ωₒ (8)

and t₂≦t₁.

In the discontinuous mode, the initial and final current values are both zero, ie, I₁₀=I₁(t₂)=0. Thus, using equations (2) and (6) gives:

−V_{cr0}+ΔV_{cr}=V₁−(V₁−V_{cr0})cos(ωₒt₂) (9)

Substituting equation (8) in equation (9) gives:

ΔV_{cr}=2V₁ (10)

Equation (10) proves that the peak capacitor voltage rises in a single cycle, and is always applicable in discontinuous mode. Notably, this condition is independent of the LC circuit parameters, the voltage level at the high voltage side, the loading, and the actual operating frequency.

Combining equations (10) and (7) gives the basic converter design principle:

I₂/V₁=2Cᵣf, {f≦2fₒ} (11)

It can be seen that the voltage stepping ratio is not a factor in this equation. This means that there is no theoretical limit on the output voltage V₂, and thus the stepping ratio achieved by the converter, and that the stepping ratio is only relevant in selecting the component rating. It can also be concluded that the converter is designed on the basis of the current I₂ (the current on the high voltage side). The converter loading can also theoretically be infinitely large, provided the capacitor and the switching frequency are sufficiently large. Equation (11) shows that the present invention is fundamentally different from conventional boost converters because, with conventional boost converters, the voltage ratio is directly dependent on the control signal.

The discontinuous operating mode of the present invention yields low switching losses, because switches are made at zero current and a smaller inductor can be used. However, the I₁ ripple is larger than it is in the continuous mode. To minimise the I₁ ripple when the discontinuous operating mode is used under normal loading, the highest switching frequency possible in discontinuous mode can be employed. Ie, the switching frequency will be f=2fₒ.

FIG. 5 shows the output current curves as a function of capacitor size and inductor size, for a switching frequency of f=2fₒ, and where the input voltage V₁=4 kV. From FIG. 5, it can be concluded that, with the components prescribed in Table 1, ie Cᵣ=20 mF and Lᵣ=0.05 H, the current of around 50 A is achieved. This is equivalent to 4 MW of output power where V₂=80 kV.

The average input current in discontinuous mode is obtained by averaging (1), with I₁₀=0:

$$\begin{matrix}{I}_{lav} = ( 1 / {t}_{1 〉} {\int }_{0}^{t 2} ( {V}_{1} - {V}_{cr 0} / {z}_{0} ) sin ( {ω}_{o} t ) d t \\ = ( {V}_{1} + {V}_{2} ) 2 f / {ω}_{o} {z}_{o} \{ f \leq 2 {f}_{o} \}\end{matrix} \qquad ( 12 )$$

The peak value of the input current is:

I₁ₒ=(V₁−V₂)/zₒ {f≦2fₒ} (13)

If the current I₂ is known, then the voltage V₂ can be obtained from the power balance equation I₁V₁=I₂V₂.

The continuous mode operation of the present invention is considered below.

Continuous mode operation is achieved when the converter operates with a switching frequency of f>2fₒ.

In continuous mode operation, the initial current is greater than zero, ie, I₁₀>0. It is therefore necessary to consider both current and voltage equations. Using equations (1), (2) and (6), combined with the condition that t₂=t₁, in steady-state:

I₁₀[1−cos(ωₒ/f)]=((V₁−V_{cr0})/zₒ)sin(ωₒ/f) (14)

and:

Δv_{cr}=V₁[1−cos(ωₒ/f)]+V_{cr0}[1+cos(ωₒ/f)]+zₒI ₁₀ sin(ωₒ/f) (15)

Equations (14) and (15) assume that, in steady-state:

I₁(t=t₁)=I₁₀ and V₂=V_{cr0}=constant (16)

Equations (14) and (15) can be used to investigate the capacitor voltage rise ΔV_{cr} (the energy storage) as the frequency is increased. In this respect, equation (14) demonstrates that the current I₁₀ continuously increases with increasing frequency.

Replacing I₁₀ from (13) in (14) gives equation (10), as derived for the discontinuous mode operation. Accordingly, condition (10) is universally applicable in all steady-state conditions, whether the operation is discontinuous or continuous, where I₁(t₁)=I₁₀. This conclusion means that equation (11) must also be valid in continuous mode.

By applying equation (11) in continuous mode, for a given Cᵣ, V₁ and a constant V_{cr0}, it can be concluded that output current and power increase as the switching frequency increases.

The average current I₁ₐᵥ can be obtained by averaging equation (1) and replacing I₁₀ from equation (14). This gives the following equations for the continuous mode:

I₂/V₁=2Cᵣf {f>2fₒ} (17)

I₁ₐᵥ=(V₁+V₂)2f/ωₒzₒ {f>2fₒ} (18)

I_{1P}=((V₁+V₂)/zₒ)√(2/(1−cos(ωₒ/f)) {f>2fₒ} (19)

In a practical system, the frequency can not be increased indefinitely, due to increased switching losses and limitations imposed by the material properties of switches and their snubber circuits. In particular, the capacitor voltage undergoes voltage change from V_{cr0} to −V_{cr0} (ie, 2V₂) in a single cycle. This imposes significant dV/dt on the switches as the frequency increases. Simulation tests indicate that, in the continuous mode, the current I₂ reaches a peak and saturates as the frequency increases.

The study below considers operation with various internal converter losses. Simulation tests with realistic switches and parasitic losses indicate that the current I₂ reaches a peak and saturates as the frequency increases. Under these conditions, equation (10) will not hold and the system will behave as if driving a frequency dependent internal load.

FIG. 6 shows typical curves for ΔV_{cr} and the output power P₂ for the test system data given in Table 1, with realistic parasitic losses. Operation at constant output voltage, V₂=80 kV, is assumed.

It can be concluded from FIG. 6 that load current and power increases with switching frequency up to a threshold frequency, above which the load current and power drop to zero. It is therefore desirable to operate at or below this threshold frequency, ie, the frequency which gives maximum power. The value of the threshold operating frequency depends on the particular converter parameters and also on the gain, and would therefore need to be calculated to be suitable for the specific application.

The operating point at the maximum power (P₂=8MW) in FIG. 6, ie, f=900 Hz, gives an output current of I₂=100 A, which is 2 times larger than the maximum output current for the discontinuous mode calculated from equation (11). From FIG. 5, it can be seen that a 80 μF capacitor (4 times larger) would be needed to achieve the same power, with the same inductor, in discontinuous mode.

This represents a significant advantage of the continuous operating mode, although switching stresses will be increased.

Operation (both continuous and discontinuous) with a constant impedance load is considered below. If a constant impedance load is used, then the load current is I₂=−V_{cr0}/R₂, where R₂ is the load impedance. Replacing this requirement in equations (11) to (13) for discontinuous mode operation and equations (17) to (19) for continuous mode operation gives the theoretical current and voltage curves shown in FIG. 7.

From FIG. 7, it can be seen that, with constant impedance load, the output voltage V₂ is linearly proportional to the frequency f. The current I₁ is a piecewise linear function, with higher gain in continuous mode than in discontinuous mode. The output power will therefore be a parabolic function of the operating frequency.

From FIG. 7 and equations (11) and (17) it is concluded that the proposed converter should be controlled by varying the switching frequency. If the system is required to operate in both continuous and discontinuous mode, the controller should have some form of gain scheduling to compensate for gain change at the transition between modes. Because of the linear control characteristic, the control method for the above converter in both modes is very simple. This is a significant improvement over conventional boost converters, which are difficult to control because they have highly non-linear and voltage-dependent controller gain, particularly in the high boost region [1].

In summary, the following steps can be followed in designing a converter suitable for a specific application.

Assuming that V₁, V₂, and the required power transfer I₂ are given, and also considering the nature of the switches, the desired operating frequency f can be determined.

The initial working value for the capacitance Cᵣ can be determined from equation (11), ie, Cᵣ=I₂/(2fV₁).

If discontinuous mode is required, then the value for the inductor is calculated (from f≦2fₒ) as Lᵣ≦1/(π²f²Cᵣ).

If, on the other hand, continuous mode operation is required, then the value for the inductor should be calculated to minimise input current ripple using equations (18) and (19).

With regard to choosing a suitable inductor, in addition to the greater size and cost of a larger inductor, too large value of Lᵣ may create operating problems. Accordingly, the ratio f/fₒ should be limited according to practical limitations.

Practical simulations with realistic dV/dt limitations and switching losses can be used to determine final parameter selection.

The value for high voltage capacitor Cₒ is determined in terms of the maximum tolerable output voltage ripple ΔV₂, the operating frequency f, and the load current I₂ as Cₒ=I₂/(ΔV₂f).

FIG. 17 shows a circuit diagram for a step-up converter 170 in accordance with a second embodiment of the present invention.

At the low voltage side, the topology of the converter 170 is similar to that of the converter 20 of FIG. 2, and the above description of this part of the converter applies here. It will be noted that the inductor L₁ in FIG. 17 is equivalent to the inductor Lᵣ in FIG. 2.

However, with the converter of FIG. 2, the block 22 is connected to the circuitry on the high voltage side of the converter via nodes a and b, respectively located between switches T₁ and T₂ and switches T₃ and T₄. In contrast, with the converter of FIG. 17, the block 22 is connected to the circuitry on the high voltage side via nodes d and c respectively located between switches T₁ and T₃, and switches T₂ and T₄, ie, either side of the capacitor Cᵣ.

Further, with the converter of FIG. 17, the diode D₂ and capacitor Cₒ are replaced by a four diode bridge rectifier (D₅ to D₈), and a second (optional) inductor L₂. The diodes D₅ to D₈ are arranged as two pairs, D₅ and D₇, D₆ and D₈. The diodes in each pair are connected together in series. Each pair of diodes is connected in series with the inductor L₂ across the high voltage terminals. The capacitor Cᵣ is connected between nodes c and d, respectively located between the two pairs of diodes. Diodes are the simplest switches in this rectification circuit, but other switches (like thyristors) may be employed instead.

As mentioned above, the configuration of the low voltage side of the converter is similar to that of the converter 20 of FIG. 2. Accordingly, the controller of FIG. 3 may be used to control the switching of the converter 170 of FIG. 17, and the operation is as described above in relation to the converter 20 of FIG. 2.

Thus, the rotating capacitor Cᵣ produces an alternating voltage V_{cr2} (equivalent to V_{cr} in the description of the first embodiment). The diodes D₅ to D₈ act to rectify the alternating voltage of the rotating capacitor Cᵣ, so as to enable a current I₂ to flow between the capacitor and the high voltage terminals in the direction indicated in FIG. 17.

The second inductor L₂ is not essential for operation. However, a small inductor will reduce the harmonics on the current I₂ at the high voltage terminals and reduce current derivatives in the diodes D₅ to D₈.

FIG. 8 shows circuit 80 for a bi-directional converter in accordance with a third embodiment of the present invention. The topology is similar to that of the converter of FIG. 2, except that a diode D₁ is connected between the inductor Lᵣ and the switching block 22, and a block 82 which comprises a pair of thyristor switches Tᵤ and T_{d} connected together in parallel, replaces the diode D₂. Further, a small inductor L_{d} is connected in series with the block 82, and the high voltage capacitor Cₒ and load R₂ are replaced by a constant polarity DC voltage, V₂, at the high voltage side.

In the case of step-up operation, thyristor Tᵤ is permanently on and T_{d} is permanently off. In step-down mode, thyristor Tᵤ is off and thyristor T_{d} is fired towards the end of voltage rise period, as indicated in the control system for the converter illustrated in FIG. 9. If only step down operation is required, then Tᵤ can be omitted.

In the embodiment of FIGS. 8 and 9, the firing instant for T_{d} is given 25 degrees before the capacitor rotation, which is fired at 155 and 335 degrees. However, the phase angle at which the thyristor T_{d} is fired will depend on the practical application, and can be adapted. If the firing is later, ie, closer to 180 and 360 degrees, the voltage stress on the thyristors is reduced, but the safe thyristor turning-off might be endangered. The thyristor T_{d} should switch off before the next capacitor rotation. This is achieved by the small inductor L_{d}, which creates resonant turn off with the capacitor Cᵣ. The use of a single thyristor T_{d} is the simplest method for connecting the capacitor Cᵣ with the high-voltage terminals in step down mode. As with the step up operation discussed above, it is possible to use multiple thyristors and to connect to the capacitor at any of nodes a, b, c and d.

An approximate value for the inductance of the inductor L_{d} is given by L_{d}˜Lᵣ/50. This gives ˜25 degrees half-period for L_{d}−Cᵣ on the main LᵣCᵣ cycle (for operation at the border of discontinuous mode). With this interval, the current through the inductor extinguishes before the next firing of main switches T₁ to T_{4.}

The bi-directional converter of FIG. 8 is designed for connection to a constant polarity DC voltage at high voltage side (V₂). Thus, current I₂ changes direction for power reversal. At the low voltage side, power reversal is achieved by changing the polarity of voltage V₁, as would be required with a thyristor inverter.

Table 2 summarises the signs of the input and output variables in the step-up and step-down operating modes.

TABLE 2

| Mode | V₁ | I₁ | V₂ | I₂ |
|---|---|---|---|---|
| Step up | + | + | + | + (Tᵤ fired) |
| Step down | − | + | + | − (T_{d} fired) |

The above described operation of the bi-directional converter would be convenient for connecting a high-power line-commutated converter to a high-voltage DC bus. Different options with voltage/current polarity change are also possible.

FIGS. 10a and 10b give details of the simulation of the step-down operation of the bi-directional converter of FIG. 8, using the test system data given in Table 1.

From FIGS. 10a and 10b, it can be seen that the main switches, T₁ to T₄, are operated in the same fashion as with the step-up operation described in relation to the converter of FIG. 2. At the end of each capacitor voltage rise, the thyristor T_{d} is fired to enable power transfer from the high-voltage source.

As can be seen from FIG. 10b, the capacitor current I_{c} peaks are higher with the step-down operation. However, the average capacitor current does not change significantly, which is important for switch ratings.

The various converters described above have been simulated with the test system data given in Table 1, using PSCAD/EMTDC professional simulator [11]. Realistic values for component losses are included. The switches are represented with typical on-state and off-state resistances, internal voltage drop, extinction time, breakover voltages, and detailed snubber circuits. It should be noted that, in general, PSCAD normally somewhat overestimates the switching losses and give pessimistic results for efficiency.

Considering first the step-up operation, FIG. 11 gives the test results for an unloaded converter and a constant frequency operation.

It can be seen from FIG. 11 that, at constant frequency, the output voltage V₂ initially increases linearly with time, and that gains of over 100 are achievable. This confirms the theoretical conclusions of positive ΔV_{cr} in each step. It can also be seen that the rate of voltage increase decreases at higher output voltages. This is the result of the increased losses and, in particular, switching losses.

Higher frequencies can be seen to achieve steeper increases in the output voltage, and thus of the gain. This confirms the conclusions in equations (11) and (17). However, gains saturate after certain frequencies.

FIG. 11 illustrates both continuous and discontinuous operation, since fₒ=159 Hz for the test system.

FIGS. 12a to 12c shows the simulation of step-up power transfer with a passive load (constant impedance) on V₂. A PI feedback control of V₂ is used.

It can be seen from FIGS. 12a to 12c, that a gain of 20 is achieved, and that 5 MW is delivered at the high power side at the switching frequency of 400 Hz. This Figure also confirms the linear control characteristics.

An operating frequency of this level would be suitable for use with thyristors of corresponding rating. The frequency can be adjusted by varying the capacitor Cᵣ. This is discussed in more detail in relation to FIGS. 13a to 13c below.

FIGS. 13a to 13c show the influence of the capacitor Cᵣ, when operating with constant impedance load.

It is evident from FIGS. 13a to 13c that a larger capacitor enables larger power transfer and operation at a lower switching frequency. This confirms the influence of capacitor size in equations (11) and (17). The smallest capacitor capable of achieving the required power transfer at the required switching frequency should be chosen due to the higher cost of larger capacitors.

The simulated responses of FIGS. 11 to 13 match well with those obtained using analytical modelling in FIG. 7. This implies that the analytical modeling discussed above, and the conclusions based on equations (10) to (19) are accurate.

FIGS. 14a to 14c illustrate the influence of inductor Lᵣ. The value of inductor Lᵣ has no influence on the load transfer, as also indicated in (11) and (17). However it has significant influence on the input current ripple.

It can be seen from FIGS. 14a to 14c that with higher Lᵣ the difference between the peak value I₁ₚ and the average value of current I₁ₐᵥ is greatly reduced.

FIGS. 15a to 15d demonstrate the responses for a 300 ms severe low-impedance fault at the voltage source V₁, which is the most likely fault location. In this case the system is operated in step-up mode transferring 5 MW power from 4 kV source to 80 kV transmission grid. The low voltage current I₁ is controlled in a PI feedback loop. It is seen that the voltage V₁ drops to zero during the fault and the current (and power transfer) is interrupted, as expected. However, this fault is not propagated to the high-voltage network, since high voltage current I₂ does not reverse and voltage V₂ is undisturbed. Since the high-power grid is undisturbed under low voltage side faults, this converter is convenient for high power applications.

Faults on the high voltage side are also well tolerated and generally not propagated to the low voltage network. For transient faults which do not reduce V₂ below the level of V₁, the converter simply recovers, as with the low voltage faults illustrated in FIGS. 15a to 15d. If the fault reduces the voltage V₂ below the value of V₁, (which is less likely) then there is potential for V₁ discharge in the fault, and control action is required. However a discharge of V₁ can be avoided by simply turning off thyristor Tᵤ, ie, not firing Tᵤ at the next firing instant.

Turning to step-down operation, FIGS. 16a to 16d show the simulation results for step-down operation, again using the test system data given in Table 1.

It can be seen from FIGS. 16a to 16d that 5 MW is transferred from an 80 kV source to a 4 kV load. The current I₁ has positive direction, but voltage V₁ changes polarity. On the high voltage side, the current I₂ changes polarity. In this case, the current I₁ is controlled, and it can be seen that the control system enables good tracking of the current reference steps.

The present invention has been described in terms of a DC-DC converter. However, a circuit which embodies the present invention could be coupled with a conventional inverter (DC-AC converter) to create a compact, high stepping ratio inverter. Further, a circuit which embodies the present invention could be connected to two AC-DC converters to build a solid-state AC-AC transformer.

The simulation tests described above have been performed for ˜MW size loads. However, the topology would be equally applicable for ˜kW range loading and low power application.

The simulation tests described focus on the low-frequency range of 300-600 Hz, which implies small switching losses. However, a converter which embodies the present invention could be made to operate at much higher frequencies. In this case, the passive components would be smaller, as required for high power density applications.

Converters which embody the present invention can be used in electronics systems for connection of low-voltage DC sources to DC networks at various power levels. They can also be used with switched-mode power supplies which require widely varying DC voltage levels, as with modern consumer electronics. They could also replace conventional high-gain DC-DC converters in many low power applications. Converters which embody the present invention also provide opportunities for better utilisation of DC electrical networks. In mixed AC-DC electrical systems, converters which embody the present invention can also be used as an alternative for conventional iron-core transformers.

### REFERENCES

[1] N Mohan, T M Undeland, W P Robbins, “Power Electronics Converters, Applications and Design,” John Wiley & Sons, 1995;
[2] L Huber, M Jovanovic “A design approach for server power supplies for networking applications” Proceedings IEEE applied power electronics conference, APEC '00 vol. 2, February 2000, pp 1163-1169;
[3] R J Wai, R Y Duan, “High step-up converter with coupled inductor” IEEE Transactions on Power Electronics, vol 20, no 5, September 2005, pp 1025-1035;
[4] Q Zhao, F C Lee “High Efficiency, high step up DC-DC converters” IEEE Transactions on Power Electronics, Vol 18, no 1, January 2003, pp 65-73;
[5] O Abutbul, et al “Step-up Switching Mode Converter With High Voltage Gain Using a Switched-Capacitor Circuit” IEEE Transactions On Circuit and Systems-I Vol. 50, no 8, August 2003, pp 1098-2002;
[6] D K Choi, et al “A novel power conversion circuit for cost effective battery fuel cell hybrid system” Elsevier Journal of Power Sources, Vol 152, (2005), pp 245-255;
[7] J G Kassakian, M F Schlecht “High-frequency high-density converters for distributed power supply systems” Proceedings of the IEEE, vol 76, no 4, April 1988, pp 362-376;
[8] S Rahul, G Honkwei, “Low cost high efficiency dc-dc converter for fuel cell powered auxiliary power unit of a heavy vehicle” IEEE Transactions on Power Electronics, vol 21, no 3, May, 2006, p 587-591;
[9] K Hirachi et al “Circuit configuration of bi-directional DC/DC converter specific for small scale load leveling system” Proc. IEE Power conversion conference, 2002, pp 603-609;
[10] Kjell Ericsson “Operational Experience of HVDC Light” Seventh International Conference on AC-DC Power Transmission. IEE. 2001, pp. 205-210, London, UK;
[11] Manitoba HVDC Research Center “PSCAD/EMTDC users manual” Winnipeg 2003.

1-17. (canceled)

18. A DC-DC power converter circuit for transferring power between low voltage terminals and high voltage terminals, the circuit comprising:
an inductor and a capacitor provided across the low voltage terminals, the capacitor being provided in parallel with the high voltage terminals;
a plurality of switches for switching the polarity of the capacitor in the circuit; and
a controller for controlling the switching of the capacitor to repeatedly switch the polarity of the capacitor at a switching frequency f, such that, in use, and other than at the instant of switching, the switched capacitor produces an increasing voltage at the high voltage side of the inductor.

19. A DC-DC power converter circuit as claimed in claim 18, further comprising a connecting device for repeatedly connecting the high voltage terminals with the switched capacitor at substantially said switching frequency to enable current flow between the switched capacitor and the high voltage terminals.

20. A DC-DC power converter circuit as claimed in claim 18, wherein said connector device comprises one or more diodes.

21. A DC-DC power converter circuit as claimed in claim 18, comprising a further inductor connected to the high voltage terminals.

22. A DC-DC power converter circuit as claimed in claim 18, wherein said connector device comprises a thyristor provided in series with a further inductor.

23. A DC-DC power converter circuit as claimed in claim 18, which is for a bi-directional converter capable of operation in step-down and/or step-up mode, wherein said connector device comprises a pair of thyristors provided in parallel, and provided in series with a further inductor.

24. A DC-DC power converter circuit as claimed in claim 18, wherein the capacitor has a value Cᵣ substantially equal to I_{2/}(2fV₁), where I₂ is the current through the high voltage terminals, f is the switching frequency and V₁ is the voltage across the low voltage terminals.

25. A DC-DC power converter circuit as claimed in claim 18, wherein the capacitor and the inductor constitute an LC circuit, and the capacitor is switched at a switching frequency f #2fₒ, where fₒ is the natural frequency of said LC circuit.

26. A DC-DC power converter circuit as claimed in claim 25, wherein the inductor has a value Lᵣ of less than or equal to 1/(π²f²Cᵣ) , where f is the switching frequency and Cᵣ is the value of the capacitor.

27. A DC-DC power converter circuit as claimed in claim 18, wherein the capacitor and the inductor constitute an LC circuit, and the capacitor is switched at a switching frequency f>2fₒ, where fₒ is the natural frequency of said LC circuit.

28. A DC-DC power converter circuit for transferring power between low voltage terminals and high voltage terminals, the circuit comprising:
an inductor and a capacitor provided in series across the low voltage terminals, the capacitor being provided in parallel with the high voltage terminals, and configured into an electronic bridge circuit comprising a plurality of switches whereby the polarity of said capacitor with respect to said low or high voltage terminals can be changed;
a controller for selectively actuating said switches so as to repeatedly switch the polarity of the capacitor with respect to the high voltage terminals at a predetermined cycling frequency; and
a connection device for repeatedly connecting the high voltage terminals to the switched capacitor at substantially said cycling frequency to enable current flow between the switched capacitor and the high voltage terminals.

29. A DC-DC power converter circuit as claimed in claim 28, wherein, other than at the instant of switching, the switched capacitor produces an increasing voltage at the high voltage side of the inductor.

30. A DC-DC power converter circuit as claimed in claim 28, wherein connector device comprises one or more diodes.

31. A DC-DC power converter circuit as claimed in claim 28, comprising a further inductor connected to the high voltage terminals.

32. A DC-DC power converter circuit as claimed in claim 28, wherein said connector device comprises a thyristor provided in series with a further inductor.

33. A DC-DC power converter circuit as claimed in claim 28, which is for a bi-directional converter capable of operation in step-down and/or step-up mode, wherein said connector device comprises a pair of thyristors provided in parallel, and provided in series with a further inductor.

34. A DC-DC power converter circuit as claimed in claim 28, wherein the capacitor has a value Cᵣ substantially equal to I_{2/}(2fV₁), where I₂ is the current through the high voltage terminals, f is the switching frequency and V₁ is the voltage across the low voltage terminals.

35. A DC-DC power converter circuit as claimed in claim 28, wherein the capacitor and the inductor constitute an LC circuit, and the capacitor is switched at a switching frequency f #2fₒ, where fₒ is the natural frequency of said LC circuit.

36. A DC-DC power converter circuit as claimed in claim 35, wherein the inductor has a value Lᵣ of less than or equal to 1/(π²f²Cᵣ) , where f is the switching frequency and Cᵣ is the value of the capacitor.

37. A DC-DC power converter circuit as claimed in claim 28 wherein the capacitor and the inductor constitute an LC circuit, and the capacitor is switched at a switching frequency f>2fₒ, where fₒ is the natural frequency of said LC circui.
